(19) United States
(12) Patent Application Publication
(10) Pub. No.: US 2006/0244843 A1
(43) Pub. Date: Nov. 2, 2006

(54) Illumination flicker detection

(76) Inventor: Bart Dierickx, Edegem (BE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/117,849

(22) Filed: Apr. 29, 2005

(51) Int. Cl. H04N 9/73

(52) U.S. Cl. 348/226.1

(57) ABSTRACT

A method and apparatus for illumination flicker detection in an image sensor using a non-linear response pixel.

### TECHNICAL FIELD

The present invention relates generally to an image sensor and, more particularly, to flicker detection in an image sensor.

### BACKGROUND

Solid-state image sensors have found widespread use in camera systems. The solid-state imager sensors in some camera systems are composed of a matrix of photosensitive elements in series with switching and amplifying elements. The photosensitive sensitive elements may be, for example, photoreceptors, photo-diodes, phototransistors, charge-coupled device (CCD) gate, or alike. Each photosensitive element receives an image of a portion of a scene being imaged. A photosensitive element along with its accompanying electronics is called a picture element or pixel. The image obtaining photosensitive elements produce an electrical signal indicative of the light intensity of the image. The electrical signal of a photosensitive element is typically a current, which is proportional to the amount of electromagnetic radiation (light) falling onto that photosensitive element.

Of the image sensors implemented in a metal oxide semiconductor (MOS) or complementary metal oxide semiconductor (CMOS) technology, image sensors with passive pixels and image sensors with active pixels are distinguished. The difference between these two types of pixel structures is that an active pixel amplifies/buffers the charge that is collected on its photosensitive element. A passive pixel does not perform signal amplification and requires a charge sensitive amplifier that is not integrated in the pixel.

One problem encountered with image sensors is flicker from illuminating light sources (e.g., a lamp) in a scene captured by a camera system. Some types of artificial illumination as fluorescent tubes flicker with frequency of 100 Hz (i.e., Europe standard) or 120 Hz (United States standard). If the image sensor frame rate in a camera is not synchronized or if the integration is not a multiple of the illumination period, undesirable artifacts as “dark banding” appear in the image generated by the camera.

Some camera systems provide no flicker detection at all and require manual intervention of the user to correct for such artifacts. Whereas, other conventional camera systems have provided some forms of flicker detection. One conventional method to detect flicker utilizes a flicker detector device that is separate from the image sensor (non-monolithic). The non-monolithic devices are based on linear response optical sensors or detection from the image information, itself. Another conventional method to detect flicker is based on extraction of beat frequencies from the image sensor signal. Such conventional flicker detection methods are expensive in hardware and/or require complex operation and manipulation (e.g., a linear response optical sensor). Moreover, detection of flicker from the image, itself, may be unreliable, and may give false triggers or lack of triggers. One major reason being that images are taken with a certain frame rate. If this frame rate happens to be in an integer ratio with the flicker frequency, flicker cannot even be detected

### BRIEF DESCRIPTION OF THE DRAWINGS

The present invention is illustrated by way of example, and not by way of limitation, in the figures of the accompanying drawings in which:

FIG. 1 illustrates one embodiment of an image sensor having a flicker detection circuit.

FIG. 2 illustrates one embodiment of detecting flicker in an image sensor.

FIG. 3 illustrates one embodiment of a flicker detection circuit.

FIG. 4 illustrates one embodiment of a method of flicker detection.

FIG. 5 is a top perspective view illustrates an alternative embodiment of an image sensor having flicker detection circuit being out of plane with respect to pixels in the pixel matrix.

FIG. 6 is a cross sectional view illustrates of an example implementation of out of plane flicker detection circuit of FIG. 5.

### DETAILED DESCRIPTION

In the following description, numerous specific details are set forth, such as examples of specific commands, named components, connections, number of frames, etc., in order to provide a thorough understanding of embodiments of the present invention. It will be apparent, however, to one skilled in the art that embodiments of present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

The following detailed description includes circuits, which will be described below. Alternatively, the operations of the circuits may be performed by a combination of hardware, firmware, and software. The term “coupled to” as used herein may mean coupled directly to or indirectly to through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines, and each of the single signal lines may alternatively be buses.

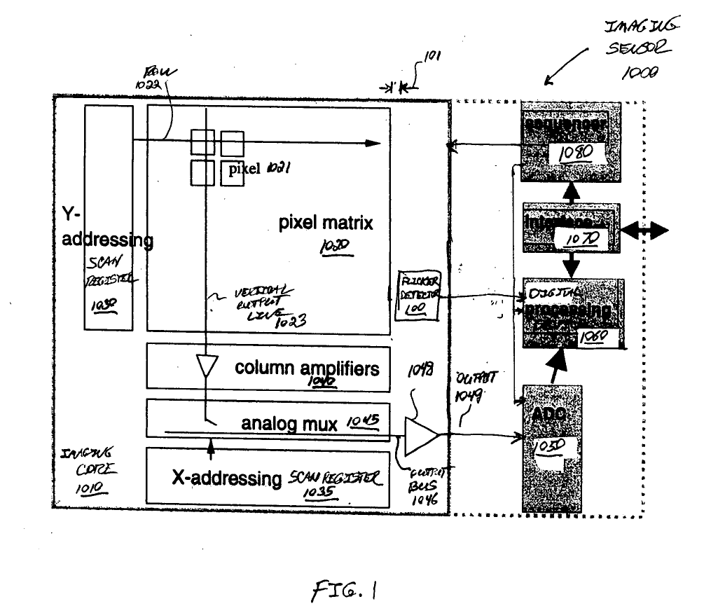

A method and apparatus for illumination flicker detection in an image sensor is described. FIG. 1 illustrates one embodiment of an image sensor having a flicker detector. Image sensor 1000 includes a pixel matrix 1020 and electronic components associated with the operation of the imaging core (imaging electronics). In one embodiment, the imaging core 1010 includes a pixel matrix 1020 having an array of pixels (e.g., pixel 1021) and the corresponding driving and sensing circuitry for the pixel matrix 1020. The driving and sensing circuitry may include: one or more scanning registers 1035, 1030 in the X- and Y-direction in the form of shift registers or addressing registers; buffers/line drivers for the long reset and select lines; column amplifiers 1040 that may also contain fixed pattern noise (FPN) cancellation and double sampling circuitry; and analog multiplexer (mux) 1045 coupled to an output bus 1046. FPN has the effect that there is non-uniformity in the response of the pixels in the array. Correction of this non-uniformity may require some type of calibration, for example, by multiplying or adding/subtracting the pixel's signals with a correction amount that is pixel dependent. Circuits and methods to cancel FPN may be referred to as correlated double sampling or offset compensation and are known in the art; accordingly, a detailed description is not provided.

The pixel matrix 1020 may be arranged in N rows of pixels (having a width dimension) by N columns of pixels (having a length dimension) with N≧1. Each pixel (e.g., pixel 1021) is composed of at least a photosensitive element and a readout switch (not shown). Pixels of pixel matrix 1020 may be linear response pixels (i.e., having linear or have piecewise linear slopes). In one embodiment, pixels as described in U.S. Pat. No. 6,225,670 may be used for pixel matrix 1020. Alternatively, other types of pixels may be used for pixel matrix 1020. A pixel matrix is known in the art; accordingly, a more detailed description is not provided.

The Y-addressing scan register(s) 1030 addresses all pixels of a row (e.g., row 1022) of the pixel matrix 1020 to be read out, whereby all selected switching elements of pixels of the selected row are closed at the same time. Therefore, each of the selected pixels places a signal on a vertical output line (e.g., line 1023), where it is amplified in the column amplifiers 1040. An X-addressing scan register(s) 1035 provides control signals to the analog multiplexer 1045 to place an output signal (amplified charges) of the column amplifiers 1045 onto output bus 1046. The output bus 1046 may be coupled to an output buffer 1048 that provides an analog output 1049 from the imaging core 1010. Buffer 1048 may also represent an amplifier if an amplified output signal from imaging core 1010 is desired.

The output 1049 from the imaging core 1010 is coupled to an analog-to-digital converter (ADC) 1050 to convert the analog imaging core output 1049 into the digital domain. The ADC 1050 is coupled to a digital processing device 1060 to process the digital data received from the ADC 1050 (such processing may be referred to as imaging processing or post-processing). The digital processing device 1060 may include one or more general-purpose processing devices such as a microprocessor or central processing unit, a controller, or the like. Alternatively, digital processing device 1060 may include one or more special-purpose processing devices such as a digital signal processor (DSP), an application specific integrated circuit (ASIC), a field programmable gate array (FPGA), or the like. Digital processing device 1060 may also include any combination of a general-purpose processing device and a special-purpose processing device.

The digital processing device 1060 is coupled to an interface module 1070 that handles the information input/output (I/O) exchange with components external to the image sensor 1000 and takes care of other tasks such as protocols, handshaking, voltage conversions, etc. The interface module 1070 may be coupled to a sequencer 1080. The sequencer 1080 may be coupled to one or more components in the image sensor 1000 such as the imaging core 1010, digital processing device 1060, and ADC 1050. The sequencer 1080 may be a digital circuit that receives externally generated clock and control signals from the interface module 1070 and generates internal pulses to drive circuitry in the imaging sensor for example, the imaging core 1010, ADC 1050, etc.

The pixel matrix 1020 and associated imaging electronics may be fabricated on one or more common integrated circuit die that may be packaged in a common carrier. In one embodiment, one or more of flicker detector 100 are disposed on the integrated circuit die outside the imaging area (i.e., pixel matrix 1020) on one or more integrated circuit die of the image sensor 1000. In such an embodiment, the flicker detector 100 may be disposed outside of the pixel matrix at a distance 101, for example, being approximately equal to or less than a dimension (e.g., width or length) of the pixel matrix 1020. It should be noted that the flicker detector is only shown on the right side of pixel matrix 1020 for ease of illustration and that the position of flicker detector 100 is not so limited. Rather, flicker detector 1020 may be disposed on any side of pixel matrix 1020. Furthermore, although illustrated inside of the imaging core 1010, the flicker detector 100 may be located outside of the imaging core anywhere in imaging sensor 1000. In addition, it should be noted that only one flicker detector 100 may be described and illustrated at times only for ease of discussion purposes but, as noted above, image sensor 1000 may include more than one of flicker detector 100.

The positioning of a dedicated flicker detector 1020 nearby the imaging area (i.e., pixel matrix 1020), for example, on the integrated circuit die(s) of the packaged image sensor 1000 (as opposed to off of the packaged device), enables the pick up of sufficient light energy due to a flare for the detection of flicker without intruding on the imaging area or imaging electronics. In an alternative embodiment, the flicker detector (or light receiving components thereof) may be incorporated into the pixel matrix 1020. For example, one or more) of the pixels of matrix 1020 (e.g., a corner or side pixel) may be replaced by the non-linear photosensitive device 205 of the filter detectors discussed below.

Flicker detector 100 may be configured to output a flag when flicker is determined to be present. In one embodiment, the flicker detector 100 may be coupled to output the flag to the digital signal processing device 1060. Based on receipt of the flag signal, the digital signal processing device 1060 may be configured to perform operations to mitigate or cancel the flicker in the light level received from pixel matrix 1020 using techniques known to one of ordinary skill in the art.

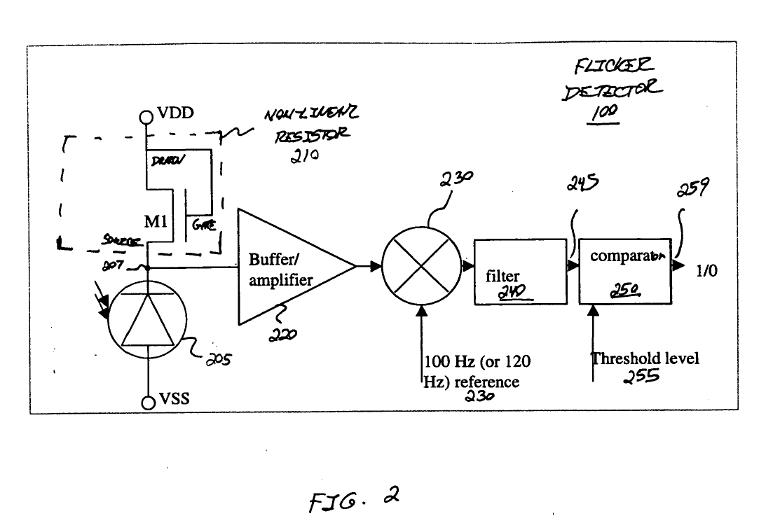

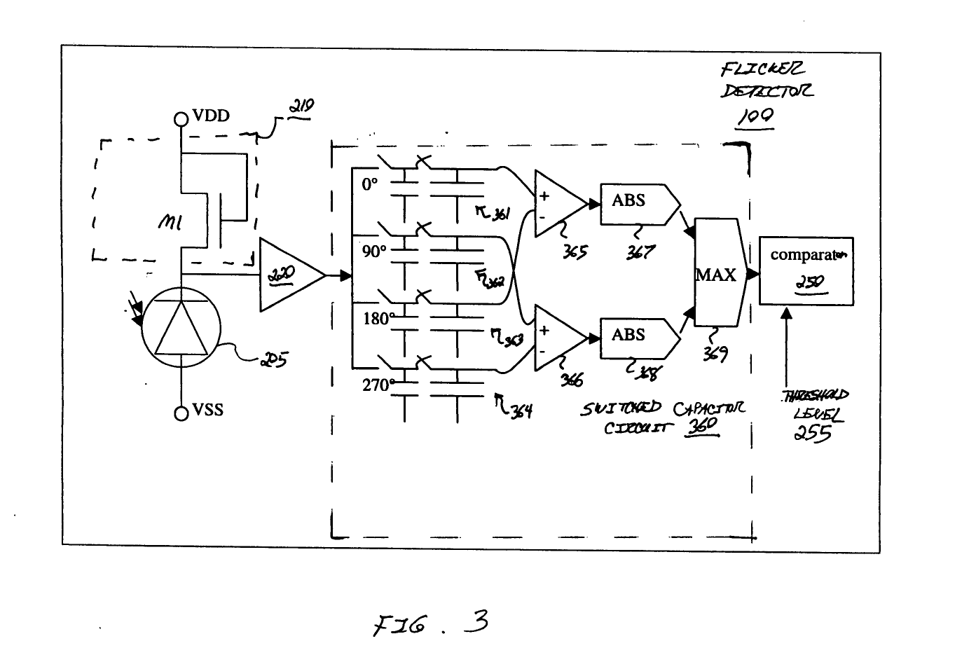

In one embodiment, flicker detector may be configured to detect the presence of 120 Hz US (100 Hz Europe) flicker in the environmental illumination seen by imaging sensor 1000, as discussed below in relation to FIGS. 2 and 3.

FIG. 2 illustrates one embodiment of a flicker detector. Flicker detector 100 includes a photosensitive device 205, a non-linear resistor 210, a buffer 220, a demodulator 230, a low pass filter 240, and a comparator 250. In one embodiment, photosensitive device 205 is a photodiode as illustrated in FIG. 2. Alternatively, other types of photosensitive devices (e.g., a phototransistor, photoresistor, etc.) may be used.

Photosensitive device 205 may be coupled in series with non-linear resistor 210 between VDD (high voltage) and VSS (lower voltage with respect to VDD). Photosensitive device 205 is, thus, biased by non-linear resistor 210. Alternative configurations may be used, for example, where the photosensitive device or the non-linear resistors are in a feedback loop. Accordingly, the configuration of photosensitive device 205 and non-linear resistor 210 may be referred to as a non-linear response pixel. In one embodiment, non-linear resistor 210 may be a logarithmic resistor and, in particular, constructed using a MOSFET M1 with its gate node tied to its drain node that is connected to VDD. In such an embodiment, photodiode 205 is coupled to the source of MOSFET M1. Alternatively, various other types of non-linear or logarithmic resistors known in the art may be used, for example, a forward biased diode or V_{BE} of a bipolar transistor that approximate logarithmic resistors.

The signal 207 at the source of M1 is then basically a voltage that is continuous in time and logarithmically proportional with the light intensity received by photosensitive device 205. If the light received by photosensitive device 205 flickers, it is seen at this point. It should be noted that the photosensitive device is a continuous time, continuous response resistively based device. Such a device requires no timing or applied clocking signal. In the embodiment where the non-linear resistor 210 is logarithmic, the device has an operation range that can span a camera's full illumination range without requiring any adjustment.

The signal 207 at the source of M1 may be coupled to a buffer 220. If amplification is desired, buffer 220 may represent an amplifier. The buffer/amplifier 220 operates to propagate signal 207 at low impedance or to bring its amplitude to a level suitable for demodulation by demodulator 230. The output of the buffer/amplifier 220 is coupled to demodulator 230. Alternatively, signal 207 may be coupled directly to demodulator 230.

In one embodiment, the demodulation performed by demodulator 230 is multiplication with a 100 Hz (or 120 Hz) reference signal 230. Alternatively, other carrier frequencies may be used. In actual implementation, multiplication may be performed with a reference signal and its 90 degree phase shifted version. The output of demodulator 230 is coupled to pass filter 240.

Pass filter 240 operates to reduce or eliminate spurious spikes due to light variations in the image scene. In one embodiment, filter 240 is a low pass filter. Alternatively, a band pass filter may be used. It should be noted that the operation of the demodulator and pass filtering may be implemented in various alternative ways, for example, band filtering before demodulation. In yet another embodiment, the functions of the demodulator and pass filter may be integrated within a single circuit component to concurrently demodulate and low-pass filter the received signal 207. In an alternative embodiment, no filtering is performed and the output of the demodulator 230 may be coupled to comparator 250, whereby filtering is optionally done after comparison

The low pass filtered signal output 245 from filter 240 represents the ratio of the amplitude of the flicker relative to the average illumination level (if present). The output 245 is provided to a comparator circuit 250 that compares output 245 to a threshold level 255. In one embodiment, threshold level 255 may be an externally supplied reference voltage. In one embodiment, the output 259 of the comparator 250 is a bit (1 or 0) that indicates whether flicker is detected. Alternatively, the output 259 may be a multiple bit output. The output 259 is then further processed by component(s) within the imaging sensor 1000 (e.g., digital signal processing device 1060) or imaging device (e.g., camera) within which the imaging sensor 1000 is situated in order to validate the presence of flicker over a longer time span. For example, in one embodiment discussed above, flicker detector 100 may be coupled to provide the output 259 to digital signal processing device 1060 for processing (e.g., correction for the presence of flicker).

FIG. 3 illustrates an alternative embodiment of a flicker detector having a switched capacitor circuit 360. In the flicker detector of FIG. 3, the operations of the demodulator 230 and low pass filter 240 of FIG. 2 are executed by switched capacitor circuit 360. In this embodiment, switched capacitor circuit 360 includes four switched capacitors 361-364 that are coupled to receive output 207 and generate waveforms (e.g., square waves or pulse trains) at 100 Hz with 0, 90 180 and 270 degrees phase shift. The outputs of the 0 and 180 degree phase shifted waveforms are coupled to a differential amplifier 365 which outputs a difference signal between the phase shifted waveforms. The outputs of the 90 and 270 degree phase shifted waveforms are coupled to differential amplifier 366 which outputs a difference signal between the phase shifted waveforms. The outputs of the differential amplifiers 365 and 366 are coupled to absolute (ABS) value circuits 367 and 368, respectively, which output absolute values of the difference signals to selection circuit 369. Selection circuit 369 selects the maximum (MAX) of the absolute values for output to comparator 250. In another embodiment, demodulation on independent sections for 0 and 90 degrees, or 0/90/180/270, or even more may be separated. Yet other alternative configurations for the flicker detector may be used as will be apparent to one of ordinary skill in the art.

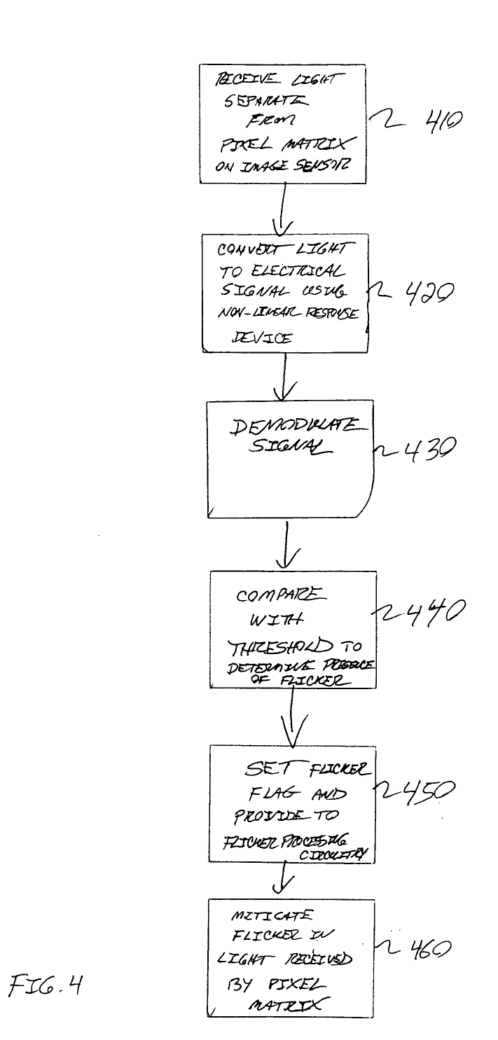

FIG. 4 illustrates one embodiment of a method of flicker detection. In this embodiment, light is received by a photosensitive device of a non-linear response pixel separate from receipt of the light by linear response pixels (in the form of a pixel matrix) that are used in an image sensor to generate an image of a scene, step 410. The light received by the photosensitive device of the non-linear response pixel is converted to an electric signal, step 420. In one embodiment, the received light is converted to an electrical signal (e.g., voltage) using a non-linear (e.g., logarithmic or near logarithmic) response device of the non-linear response pixel. The signal is demodulated with a reference frequency (e.g., 100/120 Hz), step 430. In one embodiment, the demodulated signal may be filtered.

Next, the demodulated (and filtered) signal is compared with a threshold level to determine whether flicker is present in the received light, step 440. If flicker is detected, a flag may be set and provided to processing circuitry to signal the presence of the detected flicker, step 450. In step 460, the detected flicker may be mitigated or canceled in light level received from pixel matrix of the imaging sensor.

It should be noted that although discussed at times in relation to 100/120 Hz flicker, the flicker detector 100 may also be configured to detect flicker having frequency other than 100/120 Hz in alternative embodiments.

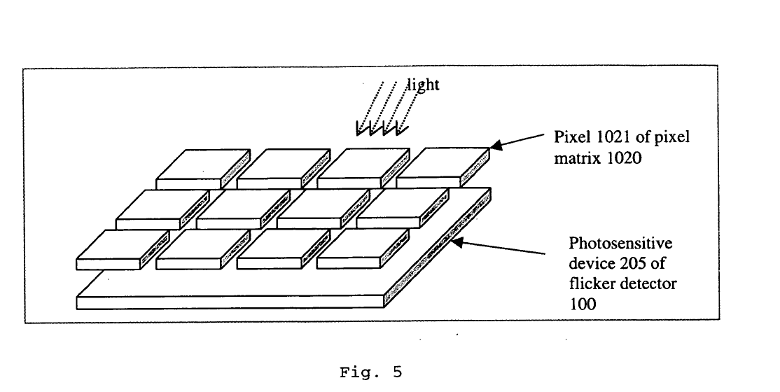

FIG. 5 is a top perspective view illustrates an alternative embodiment of an image sensor having flicker detection circuit being out of plane with respect to pixels in the pixel matrix. In this embodiment, the non-linear photosensitive device 205 of the filter detector 100 may be located within the area of the pixel matrix 1020 but out of plane with respect to the pixels (e.g., pixel 1021) of the pixel matrix 1020. One or more of the photosensitive devices 205 may reside on a different plane from that of the pixel matrix, for example, in front of or behind the pixels of the matrix. Such a different plane may have any one of various forms, for examples: a set of deeper (or shallower) photodiodes interspersed in the pixels or between the pixels; a deeper photojunction that contains all or a set of pixels; separate photodiodes implemented in the bulk of a SOI device, whereby the pixels are in the top layer of the SOI device; or a semi hybrid top layer (e.g. an amorphous Silicon top layer) on top of the pixels array, where the top layer is a photoreceptor, etc.

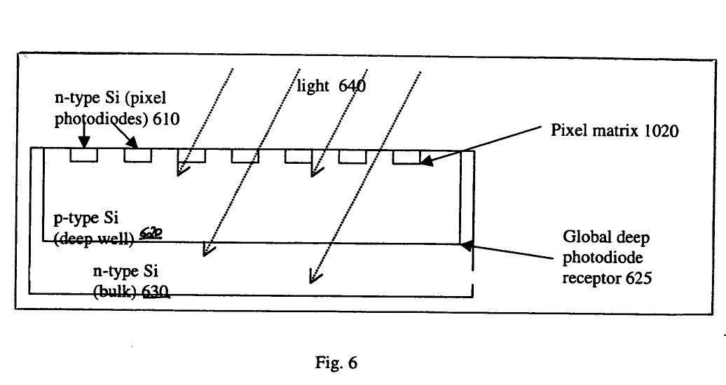

FIG. 6 is a cross sectional view illustrates of an example implementation of out of plane flicker detection circuit of FIG. 5. In this embodiment, the pixel photodiodes are n-type junctions 610 in a deep p-well 620. The global p-well 620 to substrate 630 junction acts as the receptor 625 for the flicker detection. Thus, the flicker detection receptor 625 covers the same area as the photodiodes of pixel matrix 1020, but resides on a different plane. Note that the light 640 (especially red light) has a fairly long penetration depth in Silicon, and will thus create electron hole pairs in both layers 620 and 630.

The image sensor 1000 discussed herein may be used in various applications. In one embodiment, the image sensor 1000 discussed herein may be used in a digital camera system, for example, for general-purpose photography (e.g., camera phone, still camera, video camera) or special-purpose photography. Alternatively, the image sensor 1000 discussed herein may be used in other types of applications, for example, machine vision, document scanning, microscopy, security, biometry, etc.

While some specific embodiments of the invention have been shown the invention is not to be limited to these embodiments. The invention is to be understood as not limited by the specific embodiments described herein, but only by scope of the appended claims.

What is claimed is:

1. A method, comprising:
receiving light in a photosensitive device of an imaging sensor separate from light being received by a pixel matrix of the imaging sensor to be processed for generation of an image;
converting the light received by the photosensitive device into an electrical signal;
demodulating the electrical signal to generate a demodulated signal; and
comparing the demodulate signal with a threshold level to determine the presence of flicker in the light being received by the pixel matrix.

2. The method of claim 1, wherein converting the light comprises converting the light into the electrical signal using a non-linear device coupled to the photosensitive device.

3. The method of claim 2, wherein electric signal is converted over a continuous time period in a logarithmic manner.

4. The method of claim 1, further comprising processing the light for generation of an image, and wherein the presence of flicker is determined approximately concurrent with the processing of the light.

5. The method of claim 1, wherein demodulating comprises demodulating the electrical signal with a reference signal having an approximate frequency of at least one of 100 Hertz or 120 Hertz.

6. The method of claim 6, further comprising filtering the demodulated signal.

7. The method of claim 1, further comprising mitigating or eliminating flicker in the light received by the pixel matrix when the presence of flicker in the light is determined.

8. An apparatus, comprising:
an imaging sensor disposed on one or more integrated circuit dies, the imaging sensor comprising:
a pixel matrix; and
a flicker detector disposed on the one or more integrated circuits dies outside of the pixel matrix.

9. The apparatus of claim 8, further comprising one or more additional flicker detectors.

10. The apparatus of claim 8, wherein the flicker detector comprises:
a photosensitive device;
a non-linear resistor coupled to the photosensitive device to output an electrical signal;
a demodulation circuit coupled to receive the electrical signal and a reference signal, the demodulation circuit to generate a demodulated signal; and
a comparator coupled to the demodulation circuit to receive the demodulated signal and a threshold level, the comparator to compare the demodulated signal against the threshold level and output a flag when the demodulated signal exceeds the threshold level.

11. The apparatus of claim 10, further comprising a plurality of demodulation circuits to operate on different phase shifted waveforms of the electrical signal.

12. The apparatus of claim 10, wherein the non-linear resistor is logarithmic or near logarithmic and wherein the reference signal has an approximate frequency of at least one of 100 Hertz or 120 Hertz.

13. An apparatus, comprising:
a plurality of linear response pixels to receive light to generate an image of a scene;
a non-linear response pixel comprising a photosensitive device coupled to a non-linear resistor, the non-linear response pixel to detect flicker in the light, wherein the non-linear response pixel and the plurality of linear pixels are disposed on a common integrated circuit die.

14. The apparatus of claim 13, wherein the plurality of linear response pixels forms a pixel matrix and wherein the non-linear response pixel is disposed outside of the pixel matrix.

15. The apparatus of claim 13, further comprising a demodulator coupled with the non-linear response pixel to receive an electric signal from the non-linear response pixel.

16. The apparatus of claim 15, wherein the demodulator is coupled to receive a reference signal having an approximate frequency of at least one of 100 Hertz or 120 Hertz, or a frequency being a division thereof.

17. The apparatus of claim 13, wherein the non-linear response pixel comprises a logarithmic or near logarithmic resistor.

18. The apparatus of claim 15, further comprising a comparator coupled to the demodulator.

19. The apparatus of claim 16, further comprising:
at least one of a buffer or an amplifier coupled between the non-linear response pixel and the demodulator;
a filter coupled between the demodulator and the comparator; and
a digital processing device coupled to the comparator, the digital processing device to correct for detect for a presence of flicker over a long period of time.

20. The apparatus of claim 13, further comprising:
a switched capacitor circuit coupled to the non-linear response pixel; and
a comparator coupled to the switched capacitor circuit.

21. The apparatus of claim 20, further comprising a digital processing device coupled to the comparator, the digital processing device to correct for flicker received by the pixel matrix.

22. The apparatus of claim 14, wherein the pixel matrix has a dimension and wherein the non-linear response pixel is disposed outside of the pixel matrix at a distance being approximately equal to or less than the dimension of pixel matrix.

23. An image sensor, comprising:
a pixel matrix disposed on a first plane within an area of an integrated circuit die; and
a flicker detector comprising a photosensitive device, the photosensitive device of the flicker detector being disposed within the area outside of the first plane of the pixel matrix.

24. The image sensor of claim 23, wherein the photosensitive device is disposed on a second plane being below the first plane of the pixel matrix.

25. The image sensor of claim 23, wherein pixels of the pixel matrix comprise an n-type junction in a deep p-well above a n-type substrate, wherein the photosensitive device comprises a deep p-well junction in the n-type substrate.

26. The image sensor of claim 23, wherein the pixel matrix comprises a plurality of linear response pixels and wherein the flicker detector comprises a non-linear response pixel, the non-linear response pixel comprising a non-linear resistor coupled to the photosensitive device.
